(19) United States
(12) Patent Application Publication
(10) Pub. No.: US 2009/0205614 A1
(43) Pub. Date: Aug. 20, 2009

(54) Device for the injection of fuel into the combusition chamber of an internal combustion engine

(75) Inventors: Jaroslav Hlousek, Golling (AT); Franz Guggenbichler, Kuchl (AT); Helmut Giessauf, Salzburg (AT); Joachim Lackner, Vigaun (AT); Bernd Kogler, Hallein (AT)

Correspondence Address: FITCH, EVEN, TABIN & FLANNERY, P. O. BOX 18415, WASHINGTON, DC, 20036, US

(73) Assignee: Robert Bosch GmbH, Stuttgart-Feuerbach (DE)

(21) Appl. No.: 11/659,498

(22) PCT Filed: Jul. 29, 2005
(86) PCT No.: PCT/AT05/00301

§ 371 Date: Feb. 6, 2007

(30) Foreign Application Priority Data
Aug. 6, 2004 (AT) A 1352/2004

(51) Int. Cl. F02M 51/00

(52) U.S. Cl. 123/476; 239/585.5

(57) ABSTRACT

In a device for the injection of fuel into the combustion chamber of an internal combustion engine, including an injector nozzle (5) and a nozzle needle (7) which is guided in a longitudinally displaceable manner within the injector nozzle (5) and, for the control of its opening and closing movements, is capable of being pressurized in the axial direction by the pressure prevailing in a control chamber (12) filled with fuel, wherein the control chamber (12) communicates with a supply line (14) and a discharge line (19), and a magnetic control valve (16) is arranged in at least one of the two lines, said magnetic control valve comprising a valve-closing member (25) coupled with an actuating member (21) and pressable against a valve seat (26), and said actuating member (21) being separated from the closing member (25) and the valve seat (26) by a bellows seal (28), the valve-closing member is configured as a valve ball and pressable against a conical valve seat (26).

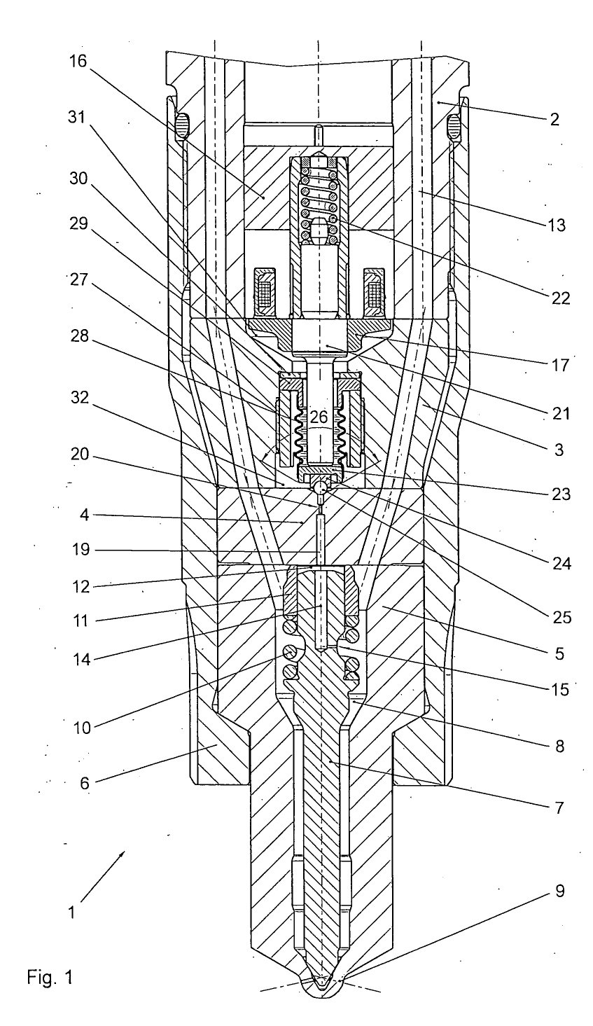

The invention relates to a device for the injection of fuel into the combustion chamber of an internal combustion engine, including an injector nozzle and a nozzle needle which is guided in a longitudinally displaceable manner within the injector nozzle and, for the control of its opening and closing movements, is capable of being pressurized in the axial direction by the pressure prevailing in a control chamber filled with fuel, wherein the control chamber communicates with a supply line and a discharge line, and a magnetic control valve is arranged in at least one of the two lines, said magnetic control valve comprising a valve-closing member coupled with an actuating member and pressable against a valve seat, and said actuating member being separated from the closing member and the valve seat by a bellows seal.

Devices of this type, which are also referred to as injectors, are frequently used for common-rail systems to inject diesel fuels into the combustion chambers of diesel engines and are usually configured in a manner that the opening and closing of the injection cross-sections are performed by a nozzle needle which is guided by a shank in a longitudinally displaceable manner within a nozzle body. The control of the movement of the nozzle needle is realized via a magnetic valve. The nozzle needle is pressurized on both sides with the fuel pressure and by a pressure spring acting in the closing direction. On the rear side of the nozzle needle, i.e. on its side facing away from the nozzle needle seat, a control chamber is provided, in which fuel under pressure pressurizes the nozzle needle in the closing direction, thus pressing the nozzle needle onto the needle seat or valve seat.

The control valve, which may for instance be designed as a magnetic valve, releases a discharge line leading away from the control chamber in order to cause a drop of the fuel pressure prevailing in the control chamber, whereupon the nozzle needle is lifted from its seat against the force of the spring due to the fuel pressure prevailing on the other side, thus releasing the passage of fuel to the injection openings. The opening speed of the nozzle needle is determined by the difference between the flow rate in the supply line to the control chamber and the flow rate in the discharge line from the control chamber, wherein a throttle is each arranged both in the supply and in the discharge lines to respectively determine said flow rates.

With conventional injectors, both the supply line to the control chamber and the discharge line from the control chamber are formed in an intermediate plate delimiting the upper side of the control chamber and, hence, arranged in the immediate vicinity of the magnetic control valve. The use of heavy oil as fuel, however, involves a number of difficulties with conventional injectors. Heavy oils have high viscosities, with heating up to 150° C. being required to lower said viscosities. This will cause the injector to be heated to beyond the usual extent, which will raise problems, particularly in the region of the magnetic valve. In particular, due to the arrangement of the supply line leading to the control chamber, and the discharge line leading away from the control chamber, in the immediate vicinity of the magnetic valve, and due to large areas of the magnetic valve, particularly the valve seat, of the valve-closing member, of the actuating member and its guide being flushed, intense heating and, hence, danger or even damage to these components will occur. The fuel contaminants adhering to heavy oil would, moreover, cause excessive wear on the components of the magnetic valve within a short time.

In order to keep heavy oil away from at least parts of the magnetic valve, a configuration has become known from DE 10026642 A1, in which the actuating member is separated from the closing member and the valve seat by a bellows seal. The arrangement of a bellows seal enables the structural division of the valve into two separate regions, namely a control region which is surrounded and traversed by heavy oil and a region that can be cooled and lubricated by motor oil, i.e. oil comprising only a negligible portion of contaminants and a lower temperature as compared to heavy oil. In the control region surrounded by heavy oil are merely arranged the valve-closing member and the valve seat such that the region exposed to the contaminants and high temperatures of the heavy oil is reduced. The remaining valve region comprising, above all, the actuating member, the guide for the actuating member and the magnet armature, will not be contacted by the heavy oil such that the wear of these components will be reduced.

The present invention aims to overcome the drawbacks encountered with the use of heavy oil, also in the region of the valve-closing member and the valve seat and to render the injector as a whole suitable for the operation with heavy oil.

To solve this object, the invention essentially consists in that the valve-closing member is configured as a valve ball and pressable against a conical valve seat. Such a configuration ensures that, on the one hand, a tight closure of the valve will be ensured even if the valve-closing member and/or the valve seat are slightly damaged by the contaminants contained in the heavy oil and, on the other hand, an exchange of the same will be readily feasible at an unduly high wear of the valve-closing member. The configuration according to the invention is to be regarded as particularly wear-resistant, while in the event of a nevertheless occurring wear or functional disorder an exchange of the valve ball and, if required, of the intermediate plate carrying the valve seat is readily feasible without affecting other components of the control valve.

In order to achieve improvements also in the region of the actuating member with regard to its compatibility with the use of heavy oil, the actuating member is advantageously configured as a pressure pin connected with the magnet armature of the magnetic control valve so as to ensure the reliable mode of functioning of the control valve. The configuration in an advantageous manner is devised such that the bellows seal is arranged between an annular upper bellows plate surrounding the actuating member and a lower bellows plate, wherein the lower bellows plate is connected with a plate, in particular ball plate, carrying the valve ball and the upper bellows plate is fastened to the valve body, the bellows seal being configurable as a metallic spring bellows. The attachment of the bellows seal to the upper and lower bellows plates in this case is realized in a tight manner, for instance by welding or gluing. In addition to the reliable separation of the two regions of the control valve, the bellows seal, moreover, ensures a reliable contact between the actuating member and the lower bellows plate on account of its spring action.

In an advantageous manner, this configuration is further developed such that the control chamber is delimited by an intermediate plate on its side facing the control valve, that the discharge line from the control chamber is designed as an axial bore provided in the intermediate plate, and that the intermediate plate carries the valve seat on the discharge line mouth facing the control valve. Thus, an intermediate plate is provided between the control chamber and the control valve, wherein both the discharge line from the control chamber and the valve seat of the control valve are arranged in said intermediate plate so as to provide a structurally simple assembly in which the intermediate plate is formed as a wear part to be replaced whenever the valve seat exhibits wear phenomena. In order to reduce such wear, it is preferably contemplated that the valve ball and the intermediate plate comprising the valve seat are made of a wear-resistant hard material. Further improvement will be obtained if the intermediate plate comprising the valve seat is made of a wear-resistant ceramic material. The arrangement of the discharge line from the control chamber, and of the valve seat, in the intermediate plate moreover enables the axial alignment of these two components so as to offer offering fluidic advantages too. The configuration in this respect is devised such that the longitudinal axis of the discharge line coincides with the longitudinal axis of the injector nozzle.

In order to ensure further reduced heating in the region of the magnetic valve, the invention is preferably further developed in a manner that the supply line to the control chamber is conducted via at least one bore of the nozzle needle. By arranging the supply line to the control chamber not in the intermediate plate as in correspondence with the prior art, but via a bore of the nozzle needle, the heat development to be observed with the use of heavy oil will be kept away from the region of the magnetic control valve and relocated in the region of the nozzle needle, which is in contact with the heated heavy oil anyway. The bore of the nozzle needle, via which the supply line is conducted to the control chamber, communicates with the nozzle fore-chamber via an supply throttle so as to provide a number of optimization options for the control of the opening and closing movements of the nozzle needle.

In the following, the invention will be explained in more detail by way of an exemplary embodiment schematically illustrated in the drawing. The latter depicts the structure of an injector for a common-rail injection system of large diesel engines. The injector 1 comprises an injector body 2, a valve body 3, an intermediate plate 4 and an injector nozzle 5, which are held together by a nozzle clamping nut 6. The injector nozzle 5 comprises a nozzle needle 7, which is guided in a longitudinally displaceable manner within the nozzle body of the injector nozzle 5 and has several clearance flanks through which fuel can flow from the nozzle fore-chamber 8 to the tip of the needle. As the nozzle needle 7 is opened, fuel is injected into the combustion chamber of the internal combustion engine through several injection openings 9.

The nozzle needle 7 comprises a collar to support a compression spring 10 which, by its upper end, presses a control sleeve 11 against the lower side of the intermediate plate 4. The control sleeve 11, the upper end face of the nozzle needle 7 and the lower side of the intermediate plate 4 delimit a control chamber 12. The pressure prevailing in the control chamber 12 is relevant to the control of the movement of the nozzle needle. Via the fuel supply bore 13, the fuel pressure, on the one hand, becomes effective in the nozzle fore-chamber 8, where it exerts a force in the opening direction of the nozzle needle 7 via the pressure shoulder of the nozzle needle 7. On the other hand, it acts in the control chamber 12 via the bore 14 and the supply throttle 15 and, assisted by the force of the pressure spring 10, holds the nozzle needle 7 in its closed position.

In the closed position of the injector, the magnet armature 17 of the magnetic valve is pressed downwards by the pressure spring 22 and, in turn, presses the valve ball 25 via the pressure pin 21, the lower bellows plate 23 and the ball plate 24 into the conical seat 26 provided in the intermediate plate 4. The upper bellows plate 29 is mounted tightly to the valve body 3 by a screw connection 27 via an adjustment disc 30. The metallic spring bellows 28 is sealingly attached to the upper 29 and lower bellows plate 23 by welding or gluing, providing sealing between the magnetic valve space 31 and the discharge space 32, on the one hand, and causing the reliable contact between the pressure pin 21 and the bellows plate 23, on the other hand.

By activating the electromagnet 16, the magnet armature 17 is lifted along with the pressure pin 21 connected therewith, while the valve seat 26 is opened. The fuel from the control chamber 12, via the discharge line 19, flows through the discharge throttle 20 and the open valve seat 26, into the pressureless discharge channel (not illustrated), which, along with the drop of the hydraulic force exerted on the upper end face of the nozzle needle 7, causes the opening of the nozzle needle 7. The fuel then reaches the combustion chamber of the motor through the injection openings 9. In the opened state of the injector nozzle 5, high-pressure fuel flows into the control chamber 12 through the supply throttle 15 and, at the same time, in a larger amount, off through the discharge throttle 20. In doing so, the so-called control amount is pressurelessly discharged into the discharge channel, i.e. drawn off the rail in addition to the injection amount. The opening speed of the nozzle needle 7 is determined by the difference in the flow rates between the supply and discharge throttles 15, 20.

As the activation of the electromagnet 16 is terminated, the magnet armature 17 is pressed downwards by the force of the pressure spring 22 and the valve ball 25 via the conical seat 26 closes the discharge path of the fuel through the discharge throttle 20. Via the supply throttle 15, the fuel pressure is again built up in the control chamber 12, generating a closing force that exceeds the hydraulic force exerted on the pressure shoulder of the nozzle needle 7 reduced by the force of the pressure spring 10. As a result, the nozzle needle 7 closes the path to the injection openings 9 and concludes the injection procedure.

In the injector represented in the FIGURE, the supply throttle 15 is not provided in the intermediate plate 4, but is arranged within the nozzle needle 7. Together with the bore 14, it provides a permanently open connection between the nozzle fore-chamber 8 and the control chamber 12. The advantage of arranging the supply throttle 15 and the discharge throttle 20 in different structural components resides in the simpler adaptation to different requirements of motor concepts and in the more cost-effective exchange at a possibly occurring wear on one of the two throttle bores.

1. A device for the injection of fuel into the combustion chamber of an internal combustion engine, including and injector nozzle and a nozzle needle which is guided in a longitudinally displaceable manner within the injector nozzle and, for the control of its opening and closing movements, is capable of being pressurized in the axial direction by the pressure prevailing in a control chamber filled with fuel, wherein the control chamber communicates with a supply line and a discharge line, and a magnetic control valve is arranged in at least one of the two lines, said magnetic control valve comprising a valve-closing member coupled with an actuating member and pressable against a valve seat, and said actuating member being separated from the closing member and the valve seat by a bellows seal, characterized in that the valve-closing member is configured as a valve ball and pressable against a conical valve seat.

2. A device according to claim 1, characterized in that the actuating member is configured as a pressure pin connected with the magnet armature of the magnetic control valve.

3. A device according to claim 1, characterized in that the bellows seal is arranged between an annular upper bellows plate surrounding the actuating member and a lower bellows plate, wherein the lower bellows plate is connected with a ball plate carrying the valve ball and the upper bellows plate is fastened to the valve body.

4. A device according to claim 1, characterized in that the control chamber is delimited by an intermediate plate on its side facing the control valve, that the discharge line from the control chamber is designed as an axial bore provided in the intermediate plate, and that the intermediate plate carries the valve seat on the mouth of the discharge line facing the control valve.

5. A device according to claim 1, characterized in that the longitudinal axis of the discharge line coincides with the longitudinal axis of the injector nozzle.

6. A device according to claim 1, characterized in that the valve ball and the intermediate plate comprising the valve seat are made of a wear-resistant hard metal.

7. A device according to claim 1, characterized in that the intermediate plate (4) comprising the valve seat is made of a wear-resistant ceramic material.

8. A device according to claim 1, characterized in that the supply line to the control chamber is conducted via at least one bore of the nozzle needle.

9. A device according to claim 1, characterized in that the control chamber, on its side facing away from the control valve, is delimited by the end face of the nozzle needle and the supply line to the control chamber is designed as an axial bore provided in the nozzle needle and connected with the nozzle fore-chamber by a supply throttle.

10. A device according to claim 2, characterized in that the bellows seal is arranged between an annular upper bellows plate surrounding the actuating member and a lower bellows plate, wherein the lower bellows plate is connected with a ball plate carrying the valve ball and the upper bellows plate is fastened to the valve body.

11. A device according to claim 2, characterized in that the control chamber is delimited by an intermediate plate on its side facing the control valve, that the discharge line from the control chamber is designed as an axial bore provided in the intermediate plate, and that the intermediate plate carries the valve seat on the mouth of the discharge line facing the control valve.

12. A device according to claim 3, characterized in that the control chamber is delimited by an intermediate plate on its side facing the control valve, that the discharge line from the control chamber is designed as an axial bore provided in the intermediate plate, and that the intermediate plate carries the valve seat on the mouth of the discharge line facing the control valve.
